(19) United States
(12) Patent Application Publication
(10) Pub. No.: US 2014/0338930 A1
(43) Pub. Date: Nov. 20, 2014

(54) Fire Mitigation System

(71) Applicant: waveGUARD Corporation, Lakewood, CO (US)

(72) Inventors: Michael H. Smith, Castle Rock, CO (US); Randy Lang, Castle Rock, CO (US); Ken DiPaolo, Golden, CO (US)

(73) Assignee: waveGUARD Corporation, Lakewood, CO (US)

(21) Appl. No.: 14/278,402

(22) Filed: May 15, 2014

Related U.S. Application Data
(60) Provisional application No. 61/823,637, filed on May 15, 2013.

(51) Int. Cl. A62C 37/36; A62C 3/02

(52) U.S. Cl. CPC A62C 37/36; A62C 3/0214
USPC 169/60

(57) ABSTRACT

A fire mitigation system is provided that employs a sprinkler system associated with the outside of a dwelling or other building. In the event of a fire, the sprinkler system is selectively activated to address excess heat or approaching flames.

This application claims the benefit of U.S. Provisional Patent Application Ser. No. 61/823,637, filed May 15, 2013, the entire disclosure of which is incorporated by reference herein.

### BACKGROUND OF THE INVENTION

Two factors have emerged as primary determinants of a home's ability to survive wildfires: choosing fire-resistant roofing material and creating a wildfire defensible zone. One of the major sources of wildfires are lightning strikes.

Lightning strikes often hit trees, power lines, transmission towers, or open ground. A fire might not start immediately after a lightning strike. And fire can smolder for a period of time before becoming a full-blown wildfire.

Most people believe that it is the advancing line of flames during a wildfire that destroys homes. However, it is the embers that create spot fires by igniting vegetation, debris, and flammable materials that eventually lead to igniting the exterior of a home.

### SUMMARY OF THE INVENTION

Sprinklers are one of the oldest methods, but one of the newest technologies in wildfire control and property fire protection. Unlike the sprinkler systems found inside buildings, these outdoor systems are not intended to put out a fire. Instead, they function in the following manner:
Sprinklers are used to thoroughly wet down specific areas. This results in cumbustibles (buildings and landscape) being much less likely to ignite due to flying embers and the intense heat of a nearby fire.
The soaked landscape releases moisture into the air. This lowers the ambient temperature and increases the humidity level of the immediate area. These effects extended some distance above ground level. The result is that the advancing wildfire will tend to be deflected by this less supportive environmental pocket and pass by the protected property.
Sprinklers are most effective when in continual operation prior to the arrival of the fire; which increases the chance of a successful defense of the property.

Embodiments of the present invention position spray heads at specifically designed locations that will wet down the structure along with a 25′-40′ perimeter around the structure. Micro-sized misting or spray heads may be placed in locations on the structure which could harbor an active ember. Such places could be under a deck, a shade structure, decorative features, attached gutters, etc. The intent is to completely wet down the area surrounding the structure as well as the structure itself. This system is designed to operate completely automatically with the assumption that the owner of structure will not be present when the system needs to operate. However, the system can be started manually should the need arise.
One embodiment of the present invention is a fire mitigation system comprising a sprinkler system associated with the outside of a dwelling or other building.
The sprinkler system is in communication with a control system.
The control system is in communication with one or more sensors.
In operation, when the sensors indicate a fire or fire-indicative event, i.e., changes in temperature, humidity, pressure, presence of flames, etc., the control system will selectively operate the sprinkler system positioned outside of the dwelling or other building.
The sprinkler system is, in one embodiment, in communication with a tank associated with the dwelling or other building.
When the fluid level in the tank reaches a predetermined level, the control system will direct the tank to be filled with water obtained from a municipal water system, a lake, a stream, a community tank that serves a plurality of dwellings or other buildings, on site, or a local well, etc.
The control system and/or sprinkler system may be remotely operated and/or monitored by way of various mobile devices, such as mobile phones, or via the Internet, etc.
The dwelling and surrounding areas may be remotely monitored (i.e., viewed) by way of various mobile devices, such as mobile phones, or via the Internet, etc.
The control system may receive data from the National Weather Service or other data sources that track the progress of fires or weather events.
The sprinkler system may have selectively adjustable sprinkler heads that may be controlled automatically by the control system or manually with a mobile device or via the Internet.

The system of one embodiment is activated when an infrared flame detector detects the flame from an approaching fire. Once the flame is detected, it sends a signal to the control panel to activate the sprinkler system to begin watering the property. While water is being pumped to the sprinkler heads, a fire retardant is injected into the system at a predetermined rate. The sprinkler heads will water a structure along with a 25′ to 40′ radius around the structure.

When the water begins to empty from the holding tank and goes below the full level sensor, the control panel then activates an electric valve that is installed on the domestic water line or well that supplies water to the house, opening it to start filling the holding tank.

The control panel will allow water to flow for a minimum cycle time of 20 minutes. After the minimum cycle time water will continue to flow as long an IR detector is detecting flames or until the water holding tank is emptied. If the IR detector or detectors don't detect flames after the initial 20 minute cycle, the control panel will begin water flow cycles of 20 minutes off, 5 minutes on until the water holding tank is emptied.

The holding tank will fill until the full level sensor in the tank is covered with water indicating the tank is full. When the tank is full, the controller closes the filling valve and continues polling the IR detectors for new flame events. During this time of filling, the controller ceases to poll the IR detectors until the water level in the tank reaches the halfway point. Any IR detector that detects a flame will trigger the controller to continue the watering of the property. If the tank was emptied as IR detectors continued to detect fire, the controller will resume watering until either the holding tank empties again, or the IR detectors cease to detect flames.

In the event that power would be shut off to the community in which the system is installed, we designed into the system a propane-powered generator that will operate the system along with the well pump to the house if the community is not on a domestic water line.

The Summary of the Invention is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detail Description, particularly when taken together with the drawings.

What is claimed is:

1. A fire mitigation system, comprising:
a sprinkler system having at least one head position outside of a dwelling;
a control system in communication with said sprinkler system;
at least one sensor in communication with the control system; and
wherein when said at least one sensor senses a predetermined event, said control system directs said sprinkler system to initiate, thereby expelling fluid in a predetermined area.
